(19) United States
(12) Patent Application Publication
(10) Pub. No.: US 2012/0150775 A1
(43) Pub. Date: Jun. 14, 2012

(54) SYSTEM FOR SEMANTIC HOME NETWORK MANAGEMENT, CLOUD INFERENCE APPARATUS FOR SEMANTIC HOME NETWORK MANAGEMENT, SEMANTIC HOME NETWORK, AND SEMANTIC HOME NETWORK CONNECTION DEVICE

(75) Inventors: Young Sung SON, Daejeon (KR); Jun Hee PARK, Daejeon (KR); Kyeong Deok MOON, Daejeon (KR)

(73) Assignee: ELECTRONICS AND TELECOMMUNICATIONS RESEARCH INSTITUTE, Daejeon (KR)

(21) Appl. No.: 13/324,398

(22) Filed: Dec. 13, 2011

(30) Foreign Application Priority Data
Dec. 14, 2010 (KR) 10-2010-0127395

(51) Int. Cl. G06F 15/18; G06N 5/02; G06N 5/04

(52) U.S. Cl. 706/12; 706/47; 706/55

(57) ABSTRACT

A semantic home network management system includes: a home network for collecting sensing information based on a state of a home network and analyzing the collected sensing information to configure semantic information; and a cloud inference apparatus for collecting and managing the semantic information provided from the home network through an internet protocol (IP) network, and applying an inference rule to the collected and managed semantic information to provide inference rule-applied semantic information to the home network. The inference rule is a rule that performs inference by recognizing at least one of a device state, a network state, a system state, and a service state.

### CROSS-REFERENCE TO RELATED APPLICATION(S)

The present invention claims priority of Korean Patent Application No. 10-2010-0127395, filed on Dec. 14, 2010, which is incorporated herein by reference.

### FIELD OF THE INVENTION

The present invention relates to a technology for semantic home network management, and more particularly, to a system for semantic home network management suitable for providing efficient information processing through time series processing on home sensing information, a cloud inference apparatus for semantic home network management, a semantic home network, and a semantic home network connection device.

### BACKGROUND OF THE INVENTION

A conventional home network management technology has been used to infer or manage home context information by a home gateway alone, and therefore has a limitation on extension and performance thereof.

In addition, in case of applying a cloud inference technology, it should be implemented or configured to match each environment, without considering different environment of each home.

### SUMMARY OF THE INVENTION

In view of the above, the present invention provides a technology for semantic home network management in which a device state, a home network state, a system state and a service state may be recognized, a pattern rule is applied thereto and a state pattern is learned in a home network environment in which multiple home networks and devices in each home network are provided and services are executed by controlling the devices through each home network, whereby information processing can be efficiently performed through time series processing on home sensing information.

In accordance with a first aspect of the present invention, there is provided a semantic home network management system including: a home network for collecting sensing information based on a state of a home network and analyzing the collected sensing information to configure semantic information; and a cloud inference apparatus for collecting and managing the semantic information provided from the home network through an Internet protocol (IP) network, and applying an inference rule to the collected and managed semantic information to provide inference rule-applied semantic information to the home network.

In accordance with a second aspect there is provided a cloud inference apparatus for semantic home network management including: a semantic information processing unit for managing first semantic information provided from a home network; and a semantic rule processing unit for applying a semantic rule to the first semantic information managed through the semantic information processing unit and performing inference on semantic rule-applied information to generate second semantic information.

In accordance with a third aspect of the present invention, there is provided a semantic home network including: a home network terminal for providing semantic information through connection to a cloud inference apparatus via an IP network, and receiving semantic information, to which a semantic rule is applied, from the cloud inference apparatus; and a home network connection device for connecting the cloud inference apparatus to a home network terminal through the IP network.

In accordance with a fourth aspect of the present invention, there is provided a semantic home network connection device including: a home network state recognition processing unit for configuring sensing information within a home network as semantic information; and a home network management unit for managing the semantic information collected within the home network, and managing rule-processed semantic information provided from a cloud inference apparatus through an IP network.

### BRIEF DESCRIPTION OF THE DRAWINGS

The objects and features of the present invention will become apparent from the following description of embodiments, given in conjunction with the accompanying drawings, in which:

FIG. 1 shows a block diagram of a semantic home network management system in accordance with an embodiment of the present invention;

FIG. 2 illustrates a detailed block diagram of a cloud inference apparatus in the semantic home network management system, in accordance with the embodiment of the present invention;

FIG. 3 illustrates a detailed block diagram of a semantic home network in the semantic home network management system in accordance with the embodiment of the present invention;

FIG. 4 provides a detailed block diagram of a semantic home network connection device in the semantic home network in accordance with the embodiment of the present invention; and

FIG. 5 depicts a detailed block diagram of a home network state recognition processing unit in the semantic home network connection device shown in FIG. 4.

### DETAILED DESCRIPTION OF THE EMBODIMENTS

Embodiments of the present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of respective blocks of block diagrams attached herein and respective steps of a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective steps of the sequence diagram.

Moreover, the respective blocks or the respective steps may indicate modules, segments, or some of codes including at least one executable instruction for executing a specific logical function(s). In several alternative embodiments, it is noticed that functions described in the blocks or the steps may run out of order. For example, two successive blocks and steps may be substantially executed simultaneously or often in reverse order according to corresponding functions.

The present invention is directed to a service technology for providing an intelligent service by collecting sensing information based on the state of a home network, analyzing the collected sensing information to configure the analyzed sensing information as semantic information, and applying an inference rule to the configured semantic information in a cloud inference system environment in which services are executed through connection with a home network to which multiple devices are connected.

In particular, the present invention may include a technology in which a home network environment is configured with a device, a network, a system, and a service such that state information thereof is sensed, sensing information collected in each of the device is configured in the form of semantic information through time series data processing such as pattern matching, noise filtering, clustering and the like, and rule inference is applied thereto in a cloud-based inference apparatus.

In a connection device within a home network, for example, a home gateway, patterns may be learned through time series processing on sensing information to generate a pattern rule, semantic information may be configured through clustering of the sensing information, and the semantic information may be transmitted to a cloud inference apparatus.

In a semantic home network environment for cloud inference, semantic information collected in each home network may be managed and an inference rule may be applied to the managed semantic information, so that various kinds of intelligent services may be supported.

Accordingly, in accordance with the present invention, an extended intelligent service may be provided by recognizing context information generated by a home network and supporting more precise context information for a user.

Hereinafter, an embodiment of the present invention will be described in detail with reference to the accompanying drawings.

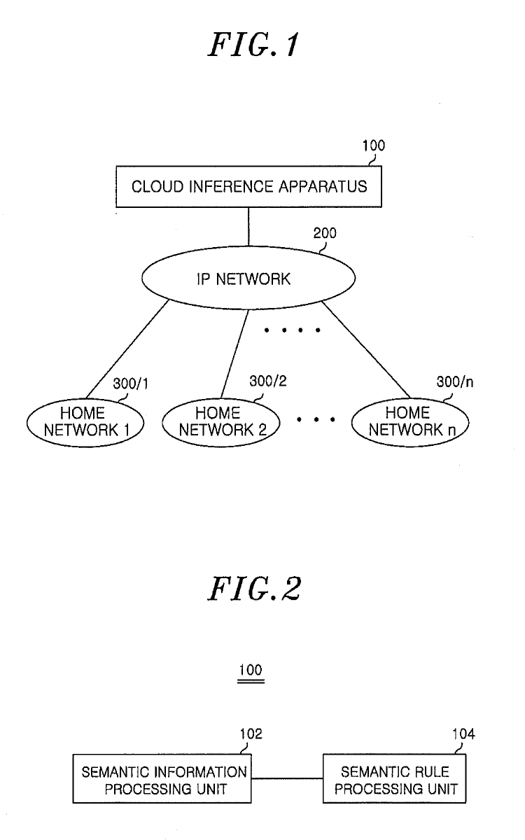

FIG. 1 illustrates a schematic block diagram of a semantic home network management system in accordance with an embodiment of the present invention. The semantic home network management system includes a cloud inference apparatus 100, an internet protocol (IP) network 200, a group of home networks 300/1 to 300/n and the like.

As shown in FIG. 1, the cloud inference apparatus 100 supports an intelligent service for managing semantic information collected from the home network group through the IP network 200 and applying an inference rule to the managed semantic information to provide the same to the home networks 300/1 to 300/n. Herein, the inference rule may include a process of recognizing and inferring, e.g., a device state, a network state, a system state, a service state, and the like.

The IP network 200 serves to connect the cloud inference apparatus 100 to the home network group. The IP network 200 may be, e.g., Internet, and refers to the worldwide open computer network structure providing a transmission control protocol/internet protocol (TCP/IP) and several services at an upper layer thereof, namely, hyper text transfer protocol (HTTP), telnet, file transfer protocol (FTP), domain name system (DNS), simple mail transfer protocol (SMTP), simple network management protocol (SNMP), network file service (NFS), and network information service (NIS). Also, the IP network 200 provides a wired/wireless communication environment through which semantic information, to which the inference rule generated from the inference apparatus 100 has been applied, may be transferred to the home network group in order to provide intelligent services, or semantic information generated by the home network group may be transferred to the cloud inference apparatus 100.

The home network group includes multiple home networks, each of which serves to collect sensing information based on the state of a home network and analyze the collected sensing information to thus configure the analyzed sensing information as semantic information.

FIG. 2 illustrates a detailed block diagram of a cloud inference apparatus for semantic home network management, for example, the cloud inference apparatus 100 shown in FIG. 1, in accordance with the embodiment of the present invention. The cloud inference apparatus 100 includes a semantic information processing unit 102, a semantic rule processing unit 104, and the like.

As shown in FIG. 2, the semantic information processing unit 102 serves to manage semantic data provided from the group of the home networks 300/1 to 300/n.

The semantic rule processing unit 104 applies a semantic rule to the semantic information managed by the semantic information processing unit 102 and performs inference on semantic rule-applied information to generate new semantic information.

The semantic information that is generated based on the semantic rule-applied information may be transmitted to the home network group through the IP network 200 such that the semantic information may be displayed to a user.

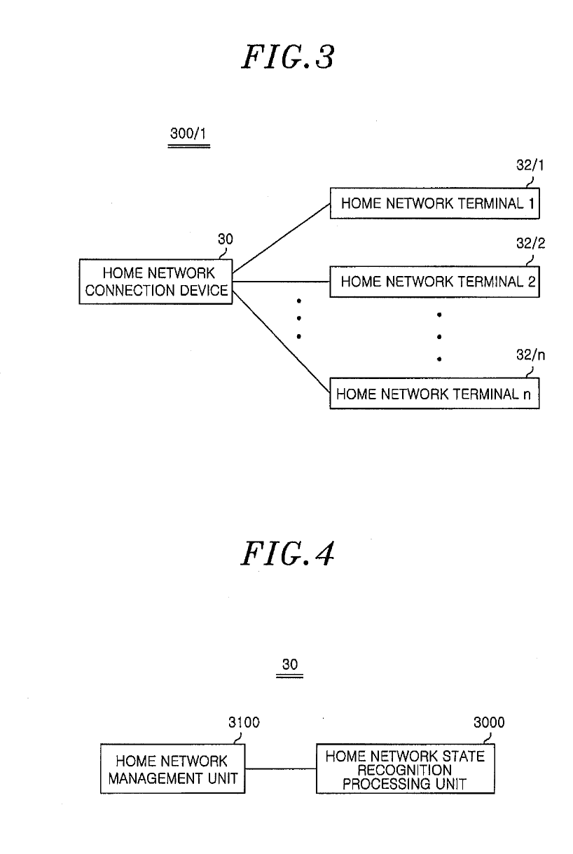

FIG. 3 illustrates a detailed block diagram of a semantic home network, for example, the home network 300/1 among the home networks 300/1 to 300/n shown in FIG. 1, in accordance with the embodiment of the present invention. The home network 300/1 includes a home network connection device 30, a group of home network terminals 32/1 to 32/n, and the like.

The home network connection device 30 may be, e.g., a home gateway, and may function to connect the cloud inference apparatus 100 to the group of the home network terminals 32/1 to 32/n through the IP network 200.

The home network terminal group 32/1 to 32/n may include various home network devices, for example, an internet protocol television (IPTV), a set-top box, a notepad, a desk top, home appliances and the like, provided within the home network 300/1. The home network terminals 32/1 to 32/n may be connected to the cloud inference apparatus 100 to provide semantic information, and may receive semantic information, to which the semantic rule has been applied, from the cloud inference apparatus 100.

FIG. 4 presents a detailed block diagram of a semantic home network connection device, for example, the home network connection device 30 shown in FIG. 3, in accordance with the embodiment of the present invention. The home network connection device 30 includes a home network state recognition processing unit 3000, a home network management unit 3100, and the like.

As shown in FIG. 4, the home network state recognition processing unit 3000 serves to configure sensing information within the home network 300/1 as semantic information through a series of processes such as time series data processing, pattern learning, clustering and the like.

The home network management unit 3100 manages semantic information collected in the home network 300/1, and further to manage rule-processed semantic information provided from the cloud inference apparatus 100 through the IP network 200.

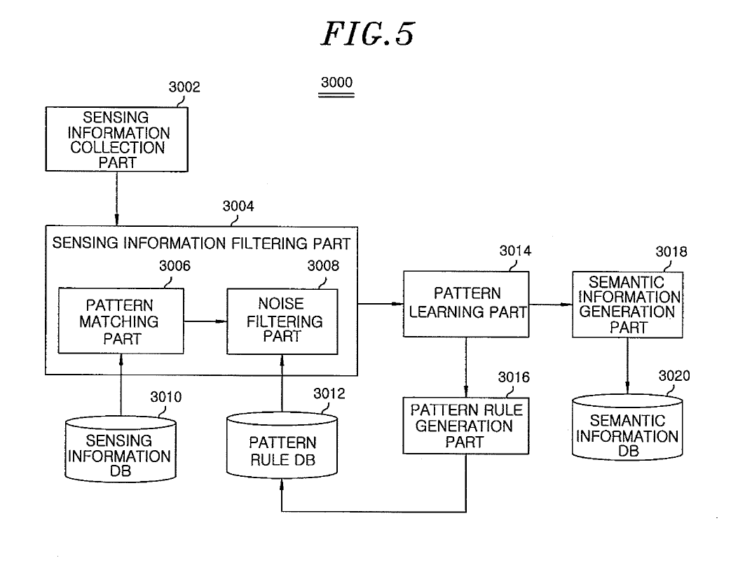

FIG. 5 illustrates a detailed block diagram of the home network state recognition processing unit 3000 shown in FIG. 4. The home network state recognition processing unit 3000 includes a sensing information collection part 3002, a sensing information filtering part 3004, a sensing information database (DB) 3010, a pattern rule DB 3012, a pattern learning part 3014, a pattern rule generation part 3016, a semantic information generation part 3018, a semantic information DB 3020, and the like.

As shown in FIG. 5, the sensing information collection part 3002 collects sensing information based on the state of the home network 300/1.

The sensing information filtering part 3004 performs time series data processing on the sensing information collected by the sensing information collection part 3002. The sensing information filtering part 3004 may include a pattern matching part 3006 for performing pattern matching on the sensing information, a noise filtering part 3008 for performing noise filtering on the pattern-matched sensing information, and the like.

The sensing information DB 3010 stores the sensing information collected by the sensing information collection part 3002, and the pattern rule DB 3012 stores a pattern rule generated by the pattern rule generation part 3016 to be described below.

The pattern learning part 3014 performs pattern learning on the time series data processing result from the sensing information filtering part 3004, and the pattern rule generation part 3016 generates a pattern rule based on the pattern learning result provided by the pattern learning part 3014.

The semantic information generation part 3018 generates semantic information through clustering of the sensing information based on the pattern learning result from the pattern learning part 3014. The semantic information DB 3020 stores the semantic information generated by the semantic information generation part 3018.

As described above, in accordance with the embodiment of the present invention, in a structure in which services are executed by controlling devices through a home network in an environment in which multiple home networks and devices are installed, a device state, a home network state, a system state and a service state may be recognized, a pattern rule is applied thereto and a state pattern is learned, whereby efficient information processing can be performed through time series processing on home sensing information. In addition, in accordance with the present invention, services can be extended such that state recognition processing can be easily performed by sharing the role thereof using a state recognition home gateway and a cloud inference system. These functions may be used may be variously applied to the field of intelligent home network services.

While the invention has been shown and described with respect to the particular embodiments, it will be understood by those skilled in the art that various changes and modifications may be made without departing from the scope of the invention as defined in the following claims.

What is claimed is:

1. A semantic home network management system comprising:
a home network for collecting sensing information based on a state of a home network and analyzing the collected sensing information to configure semantic information; and
a cloud inference apparatus for collecting and managing the semantic information provided, from the home network through an internet protocol (IP) network, and applying an inference rule to the collected and managed semantic information to provide inference rule-applied semantic information to the home network.

2. The semantic home network management system of claim 1, wherein the inference rule is a rule that performs inference by recognizing at least one of a device state, a network state, a system state, and a service state.

3. A cloud inference apparatus for semantic home network management comprising:
a semantic information processing unit for managing first semantic information provided from a home network; and
a semantic rule processing unit for applying a semantic rule to the first semantic information managed through the semantic information processing unit and performing inference on semantic rule-applied information to generate second semantic information.

4. The cloud inference apparatus of claim 3, wherein the semantic rule is a rule that performs inference by recognizing at least one of a device state, a network state, a system state, and a service state.

5. The cloud inference apparatus of claim 3, wherein the second semantic information is transmitted to the home network through an IP network.

6. A semantic home network, comprising:
a home network terminal for providing semantic information through connection to a cloud inference apparatus via an IP network, and receiving semantic information, to which a semantic rule is applied, from the cloud inference apparatus; and
a home network connection device for connecting the cloud inference apparatus to a home network terminal through the IP network.

7. The semantic home network of claim 6, wherein the semantic home network connection device includes a semantic home gateway.

8. A semantic home network connection device, comprising:
a home network state recognition processing unit for configuring sensing information within a home network as semantic information; and
a home network management unit for managing the semantic information collected within the home network, and managing rule-processed semantic information provided from a cloud inference apparatus through an IP network.

9. The semantic home network connection device of claim 8, wherein the home network state recognition processing unit includes:
a sensing information collection part for collecting the sensing information based on a state of the home network;
a sensing information filtering part for processing time series data on the sensing information;
a pattern learning part for performing pattern learning on a time series data processing result from the sensing information filtering part;
a pattern rule generation part from generating a pattern rule based on a pattern learning result provided by the pattern learning part; and
a semantic information generation part for generating the semantic information through clustering of the sensing information based on the pattern learning.

10. The semantic home network connection device of claim 9, wherein the sensing information filtering part includes:
a pattern matching part for performing pattern matching on the sensing information; and
a noise filtering part for performing noise filtering on the sensing information processed with the pattern matching by the pattern matching part.

11. The semantic home network connection device of claim 9, wherein the home network state recognition processing unit includes:
a first database for storing the sensing information;
a second database for storing the pattern rule generated by the pattern rule generation part; and
a third database for storing the semantic information generated by the semantic information generation part.

12. The semantic home network connection device of claim 8, wherein the semantic home network connection device includes a semantic home gateway.

13. The semantic home network connection device of claim 9, wherein the semantic home network connection device includes a semantic home gateway.

14. The semantic home network connection device of claim 10, wherein the semantic home network connection device includes a semantic home gateway.

15. The semantic home network connection device of claim 11, wherein the semantic home network connection device includes a semantic home gateway.
